(19) United States
(12) Patent Application Publication
(10) Pub. No.: US 2005/0151023 A1
(43) Pub. Date: Jul. 14, 2005

(54) Control system for model aircraft

(76) Inventor: David J. Ribbe, Mahomet, IL (US)

Correspondence Address: Cook, Alex, McFarron, Manzo, Cumming & Mehler;Suite 2850, 200 West Adams, Chicago, IL, 60606, US

(21) Appl. No.: 10/737,471

(22) Filed: Dec. 16, 2003

(51) Int. Cl. B64C 13/20

(52) U.S. Cl. 244/190

(57) ABSTRACT

A steering control system for a model aircraft monitors a steering control signal and determines if the signal is above a first predetermined level or below a second predetermined level, which would be indicative of a strong right turn or left turn input from a controller. A steering monitor limits the magnitude of the steering control signal if above or below the respective levels after a predetermined time delay. A throttle monitor monitors the magnitude of a throttle control signal and inhibits the steering monitor if the throttle control signal is below a predetermined magnitude to avoid limiting turns if the aircraft is operating at slower speeds. Related methods are also disclosed.

### FIELD OF THE INVENTION

This invention generally relates to systems and methods of controlling a model aircraft. More particularly, this invention relates to systems and methods of controlling a model aircraft by limiting the full range of control to prevent loss of control of the model aircraft.

### BACKGROUND OF THE INVENTION

Two key characteristics of model aircraft compete against each other in learning to fly radio-controlled model aircraft. These are stability and maneuverability. It is usually impossible to tune the aircraft for the best performance of both stability and maneuverability. Improving of one characteristic will usually detrimentally affect the other characteristic, and vice versa. The design of the model aircraft is therefore usually a compromise between these competing characteristics. The control for the aircraft may also enable one of these two characteristics to be emphasized or enhanced.

With respect to stability, the aircraft should ideally be aerodynamically stable and self-leveling. For example, if the aircraft has a low center of gravity, the aircraft generally exhibits better pitch and roll stability. Wing tips that angle upwardly provide further roll stability.

With respect to maneuverability, it is also desirable for the model aircraft to provide a crisp response to movement of the controls. This rewards the user and is frequently considered as the fun part of flying a model aircraft. It may also be necessary to maneuver the aircraft within a limited amount of space, which places further emphasis on the maneuverability characteristics of the aircraft. On the other hand, maneuverability is often reduced when the power is turned off or when the aircraft is gliding.

There is a need to limit the user's ability to over-control the aircraft, including model aircraft with good aerodynamic stability. Those persons beginning to learn to fly radio-controlled model aircraft frequently panic or over-react to the aircraft's flight conditions by holding or moving one or more of the controls to an extreme position. For example, if the steering control is held hard to one side for too long, the model aircraft may spiral, spin or dive out of control, especially if the aircraft is flying at a higher speed. Such loss of control can result in a hard ground impact, thereby subjecting the model aircraft to physical damage and resulting in a less than pleasurable experience for the user. Any damage to the aircraft can also significantly delay the next use of the aircraft while it is being repaired. Of course, if damage to the aircraft is sufficiently severe to require replacement of the aircraft, additional expense will be incurred.

There is therefore a need for a control system and methods for a model aircraft that eliminates the potentially catastrophic consequences of over-controlling the aircraft.

A need also exists for such a control system and methods that provide a limiting mode of the controls after the control has been in a maximum position for a predetermined amount of time.

Also desirable is such a control system and methods that continue to offer immediate and effective control response while in the limiting mode.

It is therefore a general object of the present invention to provide a system and methods for operating a model aircraft with improved control characteristics.

It is another object of the present invention to provide a system and methods for controlling a model aircraft when the controls are actuated to or near a maximum position.

A further object of the present invention is to provide a control system and methods that limit the amount of control after the control has been actuated to or near the maximum position for a predetermined amount of time.

Yet another object of the present invention is to provide a control system and methods for controlling a model aircraft that continues to provide effective and immediate control when the control is in the limiting mode.

Another object of the present invention is to provide such a control system and methods that are inexpensive to implement.

### SUMMARY OF THE INVENTION

The present invention is directed to an improved control system for model aircraft, such as for assisting beginning users from over-controlling the steering of the aircraft. The control system receives a radio frequency (RF) signal from a controller has a plurality of control functions, including a control for steering the model aircraft. The control system demodulates the RF signal and decodes the demodulated signal to obtain the steering control signal from the controller. Typically, the steering control signal controls one or more servomechanisms that, in turn, change the position of control surfaces of the model aircraft to provide a steering function for the aircraft.

A steering control monitor monitors the magnitude of the steering control signal and limits the magnitude of the steering control signal if it exceeds a predetermined magnitude, which is indicative of a strong steering input to the right or to the left. Similarly, the steering control monitor monitors the magnitude of the steering control signal and limits the magnitude of the steering control signal if it falls below a predetermined magnitude, which is indicative of a strong steering input to the opposite direction. A predetermined time delay may prevent limiting the steering control signal until the predetermined time delay has elapsed to avoid limiting more transient steering inputs at the controller.

Typically, the demodulation and decoding of the received RF signal also yields a throttle control signal for controlling a throttle apparatus, such as a throttle servomechanism or electric motor, and thus, the speed of the model aircraft. In accordance with another aspect of the present invention, a throttle control monitor monitors the magnitude of the throttle control signal. The throttle control monitor inhibits the steering control monitor from limiting the magnitude of the steering control signal if the throttle monitor signal indicates that the speed of the model aircraft is below a predetermined speed, since the loss of control of the aircraft at slower speeds due to larger steering commands is less likely than at higher speeds.

The present invention also includes methods of controlling the steering of a model aircraft, including the steps of receiving a signal from the controller, demodulating the received signal, decoding the received signal to recover a steering control signal, monitoring the magnitude of the steering control signal and limiting the magnitude of the steering control signal if the signal exceeds a predetermined magnitude. Additional steps may include waiting for a predetermined time delay before limiting the magnitude of the steering control signal and limiting the magnitude of the steering control signal if the signal falls below a second predetermined magnitude. Further steps may include decoding the received signal to recover a throttle control signal, monitoring the magnitude of the throttle control signal and inhibiting the steering control monitor from limiting the steering control signal if the throttle control signal indicates that the speed of the aircraft is below a predetermined speed.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a perspective view of a user with a controller for controlling the flight of a model aircraft;

FIG. 2 is a perspective view of a typical controller for a model aircraft;

FIG. 3 is a perspective view of a dual-propeller, differential thrust model aircraft that may also utilize the control system of the present invention;

FIG. 4 is a block diagram of a control system for use in the controller and model aircraft of FIGS. 1-3; and

FIG. 5 is a block diagram of the steps employed by the control system of FIG. 4 in practicing the methods of the present invention.

### DETAILED DESCRIPTION OF THE INVENTION

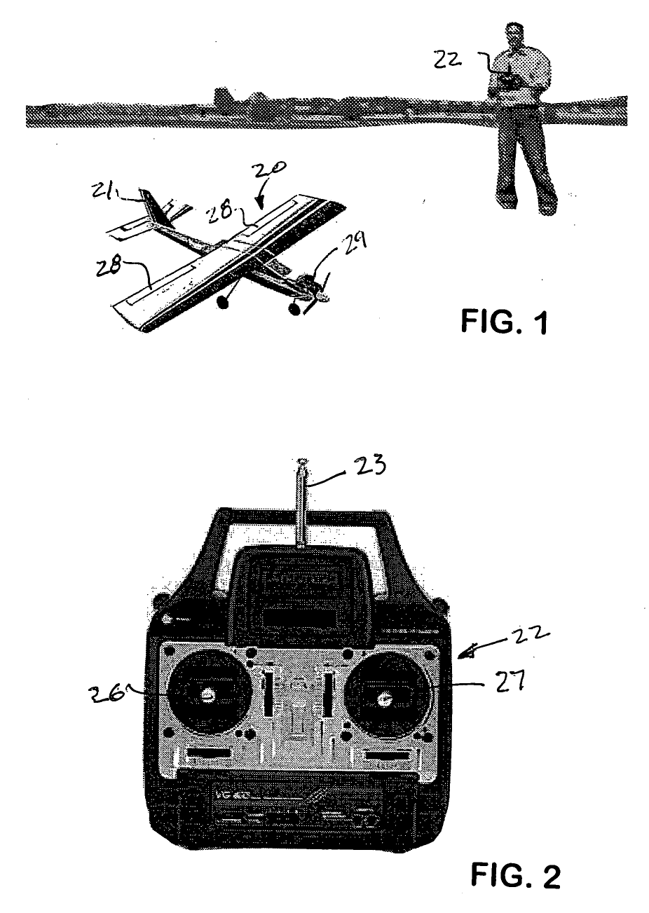

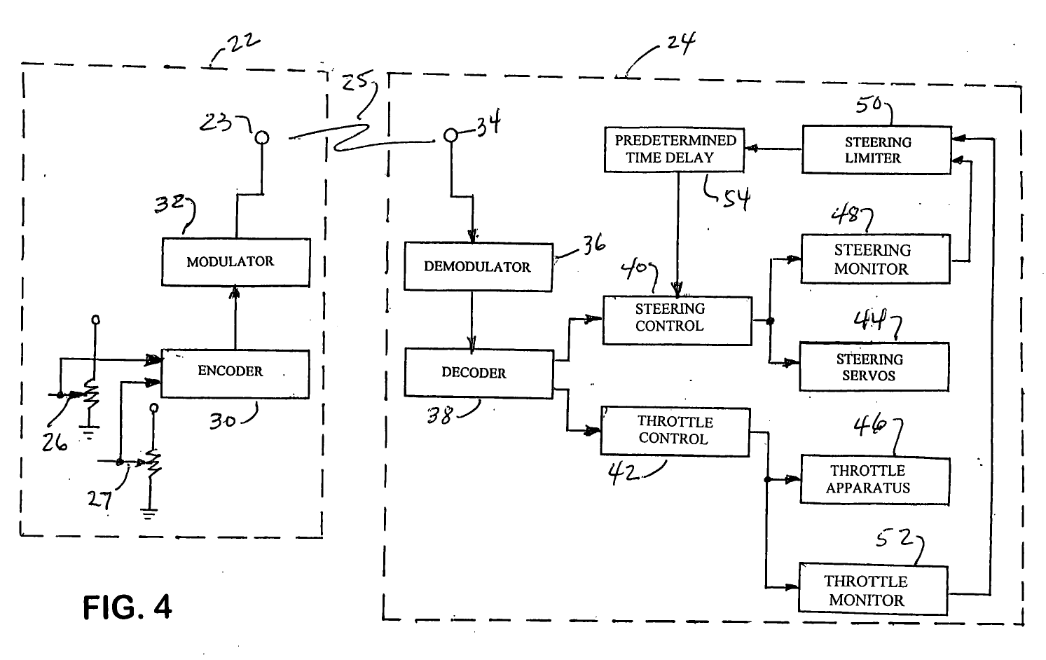

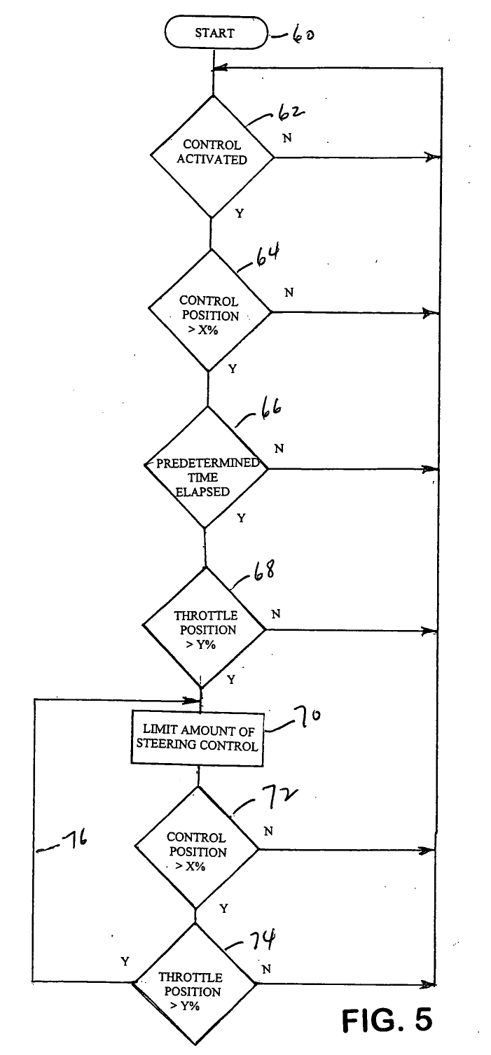

Referring to the Figures, and particularly to FIG. 1, a model aircraft, generally designated 20, is controlled by a controller 22. Such model aircraft 20 are commercially available at many hobby shops, including from authorized shops of Horizon Hobby of Champaign, Ill. As is known in the art, aircraft 20 receives radio frequency (RF) signals from controller 22. These RF signals are then processed by electronics 24, in FIG. 4, located in the aircraft to determine the various control settings of the controller 22. The electronics 24 also control servomechanisms, or the like, in aircraft 20 to change the position of various control surfaces, such as rudders 21, ailerons 28, or the like, in accordance with the determinations of the control settings of controller 22. A throttle apparatus, such as a throttle servomechanism or electric motor, is also typically used to control the throttle position of the engine 29 of the airplane to control the speed thereof. The training system of the present invention can be applied to any model aircraft with one or more controls, such as those with proportional or semi-proportional control system outputs. While the embodiments of the present invention are described herein in connection with model aircraft, it will be appreciated that the present invention may be applicable to other types of aircraft.

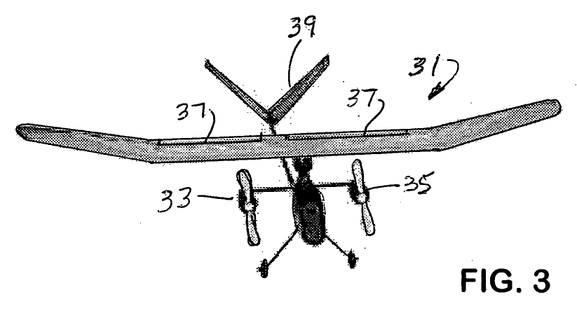

Another variation of model aircraft 20 is the model aircraft, generally designated 31, of the V-tail rudder 39 type shown in FIG. 3. Model aircraft 31 is also equipped with a pair of engines 33 and 35, and also has conventional ailerons 37. Since aircraft 31 has two engines, it can also be steered by varying the speed of the engines 33 and 35 to create a differential thrust therebetween. Controller 22 may therefore have a means for independently controlling the engine speeds of engines 33 and 35, or to adjust or vary the speed of the engines. That is, steering of aircraft 31 may be accomplished by differentially throttling the engines 33 and 35.

Controllers, such as controller 22, are also commercially available at many hobby shops. These controllers 22 are usually multi-channel devices that transmit signals by any appropriate medium, such as by frequency modulation (FM) or by amplitude modulation (AM). For example, some typically used frequencies in the FM spectrum are at about 27 or 72 MHz. Controller 22 may be either analog or digital, and the servomechanisms in the aircraft 20 for controlling the control surfaces may also be of the analog or digital types. The RF link 25 between the controller 22 and the aircraft 20 may be any standard proportional signal, a non-proportional signal or a semi-proportional signal, such as low resolution PCM. The control system of the present invention can be applied to any controller that is non-proportional, semi-proportional or proportional.

In the case where the controller 22 is proportional, the input by the user is typically by means of standard stick potentiometers 26 and 27 that are moved by the user to change the control inputs to the aircraft 20. For example, the potentiometers 26-27 may by used to control the speed of the aircraft, control the steering of the aircraft and control the elevation of the aircraft. One of these potentiometers may be used for steering control. At a mid position, no steering is desired and the aircraft flies straight. If the potentiometer is moved to the left or to the right of its mid position, the airplane begins to also turn to the left or to the right.

As seen in FIG. 4, the user-controlled inputs from potentiometers 26-27 are encoded by an encoder 30, modulated to an RF frequency by a modulator 32 and transmitted from an antenna 23 via an RF link 25 to electronics 24 contained within the aircraft 20.

The electronics 24 in the aircraft 20 receives the RF signal at an antenna 34. The RF signal is then demodulated by a demodulator 36 and decoded by a decoder 38 to recover information concerning the user-controlled inputs at controller 22, including the user's input at the stick potentiometers 26-27. For example, the decoder recovers and separates a steering control signal 40 and a throttle control signal 42 from the user's inputs at potentiometers 26 and 27. Decoder 38 may also provide other recovered information that is transmitted from controller 22 such as information to control the elevation of the aircraft 20.

The steering control signal 40 is used by one or more steering servos 44 to control the position of control surfaces of the aircraft, such as a rudder. Similarly, the throttle control signal 42 is used by a throttle apparatus 46 to control the speed of the engine and propeller of the aircraft, and hence to control the speed of the aircraft. Alternatively, the throttle control signal 42 may be used by a speed control to control the speed of an electric motor.

A long standing problem with the use of such controllers 22 by beginners has been that beginning users tend to over-compensate for the flight conditions of the aircraft 20 by moving one of the controls of the controller 22, such as the stick potentiometers 26-27, to or near a maximum position. This frequently results in the aircraft spinning or diving out of control into the ground.

In accordance with one aspect of the present invention, the control system monitors the speed of the model aircraft, the degree of steering and the elapsed time that the speed and steering parameters continue, to predict when the model aircraft may begin to spiral out of control. This may be done, by way of example, with a microprocessor or a microcontroller monitoring the respective signals and having look up tables with values that correspond to limits that will result in a spiral. The cumulative effect of the speed, degree of steering and elapsed time is thus continuously monitored. The control system then begins to intervene before the airplane begins a spiral. Typically, the intervention may be by reduction in the degree of steering control, but speed could also be reduced as the model aircraft approaches the danger point of entering into a spiral.

In a more simplified control system, a steering monitor 48 monitors the steering control signal 40 to the steering servos 44 to determine if the steering control signal is above a maximum level or below a minimum level that would be indicative of a strong or maximum right turn or a strong or maximum left turn, or vice versa. In this respect, steering monitor 48 may be a level detector that determines when steering control signal 40 exceeds a higher threshold level or when steering control signal 40 falls below a lower threshold level. Of course, steering monitor 48 can be implemented in yet other ways to accomplish the same objectives.

If steering monitor determines that the steering control signal is above or below a selected threshold level, it instructs a steering limiter 50 to limit the steering control signal to a lower or higher level, respectively, to limit the magnitude of the right turn or the left turn. For example, the steering limiter 50 may clamp, clip or attenuate the magnitude of the steering control signal to provide a more moderate right or left turn. The limiting of the steering control signal 40 by the steering limiter 50 is initially inhibited by a predetermined time delay 54 since the user's steering command may only be transient in nature. However, if the steering control signal persists past the predetermined amount of delay at a level that invokes the steering limiter 50, limiting of the steering control signal will begin. Note that at any time, if the user moderates the steering command at the controller 22, the steering limiter 50 will cease limiting the steering control signal 40 if the steering control signal no longer falls above or below the respective threshold levels.

A throttle monitor 52 monitors the throttle control signal 42 and provides a representation of the magnitude of the throttle control signal to the steering limiter 50. Since model aircraft 20 can generally handle relatively sharp right and left turns at slower speeds without loss of control, throttle monitor 52 inhibits the operation of the steering limiter at slower aircraft speeds.

Preferably, the training controller of the present invention may be activated or deactivated, as desired. With reference to block 62 in FIG. 2, the system first determines if the control system is activated. If so, decision block 64 determines if any control, such as the steering control is in or near a maximum position. If not, the monitoring of the steering control returns to block 62. If the steering control is in or near a maximum position, block 66 determines if a predetermined amount of time has elapsed. If not, the monitoring of the position of the control returns to block 62.

However, if the control has been in or near the maximum position for the predetermined amount of time, decision block 68 determines whether the throttle control exceeds a predetermined threshold or percentage of maximum throttle position. If not, no limiting of the steering control is initiated and the monitoring of the steering control returns to block 62. However, if the throttle position exceeds a defined amount, the amount of steering control is limited, as shown in block 70. For example,_the steering servo in aircraft 20 will be changed in position to reduce the amount of steering of the aircraft. The reduction in the amount of steering control may be gradual or all at once.

When the amount of steering control becomes limited, the amount of steering control continues to be monitored at block 72. If the steering input from controller 22 continues to be at or near a maximum value, the amount of control continues to be limited at block 70.

The reduction in the amount of steering control may also be dependent upon the throttle position. To this end, block 74 monitors the throttle position when the steering control becomes limited. For example, if the throttle position is below about 30 percent of full throttle, no reduction of steering position may be necessary since many model aircraft will not go into a spiral at lower speeds. However, the selected throttle position will vary for different types of model aircraft. It may therefore be desirable to be able to tailor the throttle position that begins to activate the steering position for the specific type of model aircraft.

If the throttle position is reduced below the defined threshold or maximum amount, the process returns to block 62 and the steering control is no longer limited. Otherwise, the amount of steering control continues to be limited via loop 76 until either the steering control position is reduced below the threshold or maximum level or the throttle control is reduced below the threshold or maximum level.

Controller 22 may also provide an audible status of the control system through a speaker in the controller. For example, controller 22 may advise the user whether the control system is activated by issuing audible statements, such as “Assistant pilot is on” or “Assistant pilot is off.” The system may also advise when the system is reducing the amount of steering control by issuing audible statements, such as “Right turn”, “Still holding right turn” and “Assistant pilot is reducing right turn.”

It will be understood that the embodiments of the present invention that have been described are illustrative of some of the applications of the principles of the present invention. Various changes and modifications may be made by those skilled in the art without departing from the true spirit and scope of the invention.

1. A steering control system for an aircraft, said steering control system comprising:
a steering control signal;
at least one steering servomechanism for controlling at least one control surface to steer the aircraft, said at least one steering servomechanism responsive to the steering control signal to change the position of at least one control surface;
a steering control monitor for monitoring the steering control signal and for limiting the magnitude of the steering control signal if the steering control signal exceeds a predetermined magnitude;
a throttle control signal;
a throttle apparatus for controlling the speed of the aircraft, said throttle apparatus responsive to the throttle control signal to change the speed of the aircraft; and
a throttle control monitor for monitoring the throttle control signal and for providing a throttle monitor signal to the steering control monitor;
whereby said steering control monitor does not limit the magnitude of the steering control signal if the throttle monitor signal indicates that the speed of the aircraft is below a predetermined speed.

2. The steering control system in accordance with claim 1 wherein said steering control monitor monitors the steering control signal and limits the magnitude of the steering control signal if the steering control signal falls below a second predetermined magnitude.

3. The steering control system in accordance with claim 1, said steering control system further comprising:
a predetermined time delay for delaying the steering control monitor from limiting the magnitude of the steering control signal until the predetermined time delay has elapsed.

4-5. (canceled)

6. The steering control system in accordance with claim 1, wherein said aircraft is a model aircraft.

7. A method of controlling the steering of an aircraft, comprising the steps of:
receiving a signal from a controller;
demodulating the received signal;
decoding the received signal for s steering control signal;
monitoring the magnitude of the steering control signal; and
limiting the magnitude of the steering control signal if the steering control signal exceeds a predetermined magnitude.

8. the method of controlling the steering of an aircraft in accordance with claim 7, comprising the additional step of:
waiting for a predetermined time delay before limiting the magnitude of the steering control signal.

9. The method of controlling the steering of an aircraft in accordance with claim 7, comprising the additional step of:
limiting the magnitude of the steering control signal if the steering control signal falls below a second predetermined magnitude.

10. The method of controlling the steering of an aircraft in accordance with claim 7, comprising the additional steps of:
decoding the received signal for a throttle control signal;
monitoring the magnitude of the throttle control signal; and
inhibiting the limiting the magnitude of the steering control signal if the throttle control signal indicates that the speed of the aircraft is below a predetermined speed.

11. The method of controlling the steering of an aircraft in accordance with claim 7, wherein said aircraft is a model aircraft.

12. A steering control system for an aircraft, said steering control system comprising:
means for receiving and decoding a steering control signal;
means for controlling at least one control surface to steer the aircraft, said means responsive to the steering control signal to change the position of at least one control surface of the aircraft;
means for monitoring the steering control signal and for limiting the magnitude of the steering control signal if the steering control signal exceeds a predetermined magnitude;
means for receiving and decoding a throttle control signal;
means for controlling the speed of the aircraft, said means responsive to the throttle control signal to change the speed of the aircraft; and
means for monitoring the throttle control signal and for providing a throttle monitor signal to the means for monitoring the steering control signal;
whereby said means for monitoring the steering control signal does not limit the magnitude of the steering control signal if the throttle monitor signal indicates that the speed of the aircraft is below a predetermined speed.

13. The steering control system in accordance with claim 12 wherein said means for monitoring the steering control signal limits the magnitude of the steering control signal if the steering control signal falls below a second predetermined magnitude.

14. The steering control system in accordance with claim 12, said steering control system further comprising:
means for delaying the steering control monitor from limiting the magnitude of the steering control signal until a predetermined time delay has elapsed.

15-16. (canceled)

17. The steering control system in accordance with claim 12, wherein said aircraft is a model aircraft.
